(19) United States
(12) Patent Application Publication
(10) Pub. No.: US 2004/0040043 A1
(43) Pub. Date: Feb. 26, 2004

(54) Digital receiver and controlling method thereof

(75) Inventor: Yang-Mu Heo, Suwon-city (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon City (KR)

(21) Appl. No.: 10/627,726

(22) Filed: Jul. 28, 2003

(30) Foreign Application Priority Data
Aug. 26, 2002 (KR) 2002-50634

(51) Int. Cl. G06F 13/28; H04N 7/173; H04N 7/16

(52) U.S. Cl. 725/134; 710/22; 725/142

(57) ABSTRACT

A method and apparatus to download a main program from a memory card in a digital receiver. The digital receiver includes a central processing unit, a memory, a memory card interface, and a key input unit. The method executes a boot program to initialize the digital receiver, detects a memory card insert signal triggering a search of a file having an predetermined file extension in the memory card through the memory card interface, reads and stores the file in an auxiliary memory, reads a header of the file read having the predetermined extension, determines whether the file read is the main program, downloads the main program to the memory, and determines whether the main program is downloaded by checking information of the file recorded in the header and a capacity of the main program recorded in the memory.

### CROSS-REFERENCE TO RELATED APPLICATIONS

This application claims the priority of Korean Patent Application No. 2002-50634, filed on Aug. 26, 2002, which is incorporated herein in its entirety by reference.

### BACKGROUND OF THE INVENTION

1. Field of the Invention

The present invention relates to a digital receiver, and more particularly, to a digital receiver downloading a main program using a memory card and a controlling method thereof.

2. Description of the Prior Art

Generally, a broadcasting signal receiving apparatus, such as a set-top box, is a communication terminal apparatus that decodes compressed signals transmitted from a video server through a digital network to original video and audio signals. Hereinbelow, descriptions will be presented about the set-top box exemplifying the broadcasting signal receiving apparatus. When the set-top box receives digitized information from a service provider, if video signals exist in the received information, the set-top box converts formats of the digitized video signals to displayable formats. If the digitized audio signals exist in the received information, the set-top box converts the audio signals in a digital form to analog signals so that the audio signals can be output through a speaker. The set-top box is used to structure a Video On Demand (VOD) system. Also, the set-top box is used as a communication apparatus for receiving data through the Internet. The set-top box serving as the communication apparatus can be used as an Internet user interface when the set-top box is connected to a television. The television connected to the set-top box performs a web television function.

Programs that are executed in the set-top box include a boot program and a main program. The boot program initializes the set-top box, and is generally stored in a memory provided in the set-top box when the set-top box is fabricated. The main program performs various functions of the set-top box, and can be changed according to a user's needs. For example, a User Interface (UI) and an Electronic Program Guide (EPG) belong to the main program. The main program has to be downloaded from an external device and stored in a memory by the user.

FIG. 1 is a block diagram showing a conventional set-top box connected to an external PC 30 to download the main program. As shown in FIG. 1, the set-top box 10 includes a central processing unit 11 for controlling general operations of the set-top box 10 and a memory 12 for recording and storing the information therein through a control of the set-top box 10.

The set-top box 10 has to download a main program from the external PC 30. In order to download the main program, data communication must exist between the external PC 30 storing the main program therein and the set-top box 10. For the data communication, the conventional set-top box 10 uses a Data Control Unit (DCU) 20 or a serial communication.

The DCU 20 directly connects the set-top box 10 and the PC 30 for a high-speed data communication. While the DCU 20 operates as a master, the central processing unit 11 of the set-top box 10 and the PC 30 operate as a slave. The utilization of the DCU 20 allows the set-top box 10 to download both the main program and the boot program. The downloaded programs are stored in the memory 12.

In case of using serial communication, the PC 30 and the set-top box 10 include corresponding serial ports. The serial ports are connected to each other by serial cables so that the main and boot programs are downloaded through the serial ports. The downloading of the main program by using the serial communication is controlled by the central processing unit 11 of the set-top box 10 after the set-top box 10 is booted. FIG. 2 is a flowchart showing a process of downloading the main program of the set-top box of FIG. 1. As shown in FIG. 2, at operation S10, a system of the set-top box 10 is initialized by the execution of the boot program and, at operation S11, the process determines whether or not the main program is stored for execution.

When it is determined that the main program is not stored or that the stored main program is damaged, at operation S12, the process determines whether or not the DCU 20 is connected to the set-top box to download the main program. When the process determines that the DCU 20 is connected, at operation S14, the DCU 20 allows the main program to be downloaded from the PC 30 to the set-top box 10. At operation S15, the downloaded main program is stored in the memory 12. Meanwhile, when the process determines that the DCU 20 is not connected, at operation S13, the process determines whether the downloading of the main program by using the serial communication is possible.

When the process determines that the downloading of the main program by using the serial communication is possible, at operations S14 and S15, the main program is downloaded through the serial communication and stored in the memory 12. When the main program is stored in the memory 12, at operation S16, the system is re-booted through a reset and, at operation S17, returns to a main root. When the process determines that the serial communication is not possible, the system returns to the main root and displays an error.

As described above, the set-top box has to be connected to the PC 30 through the DCU 20 or the serial communication in order to download the main program. Therefore, a problem occurs where the main program cannot be downloaded in the absence of the PC 30. A cost problem also occurs because the expensive DCU 20 is needed to download the main program. Also, because the set-top box has to be provided together with the PC 30 and the DCU 20 in one space to download the programs, there is a problem of spatial restriction.

### SUMMARY OF THE INVENTION

Additional aspects and/or advantages of the invention will be set forth in part in the description which follows and, in part, will be obvious from the description, or may be learned by practice of the invention.

According to an aspect of the present invention, there is provided a digital receiver, including a memory card storing a main program; a memory; a central processing unit controlling operations of the digital receiver and the memory; a memory card interface electrically coupling the memory card and the central processing unit; and a key input unit receiving a control command from a user and outputting a key signal to the central processing unit to control the memory card to directly download the main program from the memory card to the memory.

According to an aspect of the present invention, there is provided a method of downloading a main program from a memory card in a digital receiver, wherein the digital receiver includes a central processing unit, a memory, a memory card interface, and a key input unit, the method including: executing a boot program to initialize the digital receiver; detecting a memory card insert signal triggering a search of a file having a predetermined file extension in the memory card through the memory card interface; reading and storing the file in an auxiliary memory; reading a header of the file read having the file extension and performing a checksum; determining whether the file read is the main program; downloading the main program to the memory; and determining whether the main program is downloaded by checking information of the file recorded in the header and a capacity of the main program recorded in the memory.

According to an aspect of the present invention, there is provided a method of downloading a main program from a memory card in a digital receiver using a data control unit (DCU) or a serial communication, wherein the digital receiver includes a central processing unit, a memory, a memory card interface, and a key input unit, the method including: executing a boot program; receiving a memory card selection key to download a main program directly from the memory card through the memory card interface, wherein the memory card selection key signal is set by an input signal from the key input unit; downloading the main program from the PC through the DCU when the memory card selection key signal is not input; downloading the main program from the PC through the serial communication when the DCU is unavailable and the memory card selection key signal is not input; storing the main program in the memory; rebooting the system through a reset; and executing the main program.

### BRIEF DESCRIPTION OF THE DRAWINGS

These and/or other aspects and/or advantages of the invention will become apparent and more readily appreciated from the following description of the aspects of the present invention, taken in conjunction with the accompanying drawings of which:

FIG. 1 is a block diagram showing a conventional set-top box connected to an external PC;

FIG. 2 is a flowchart showing a process of downloading a main program of the set-top box of FIG. 1;

FIG. 3 is a system block diagram showing the set-top box, according to an aspect of the present invention;

FIG. 4 is a view schematically showing a data structure of a memory of FIG. 3;

FIG. 5 is a connection relationship of the system of FIG. 3;

FIG. 6 is a flow chart showing a process of downloading the main program of the set-top box of FIG. 3, according to an aspect of the present invention; and

FIG. 7 is a flowchart showing another process of downloading the main program of the set-top box of FIG. 3, according to an aspect of the present invention.

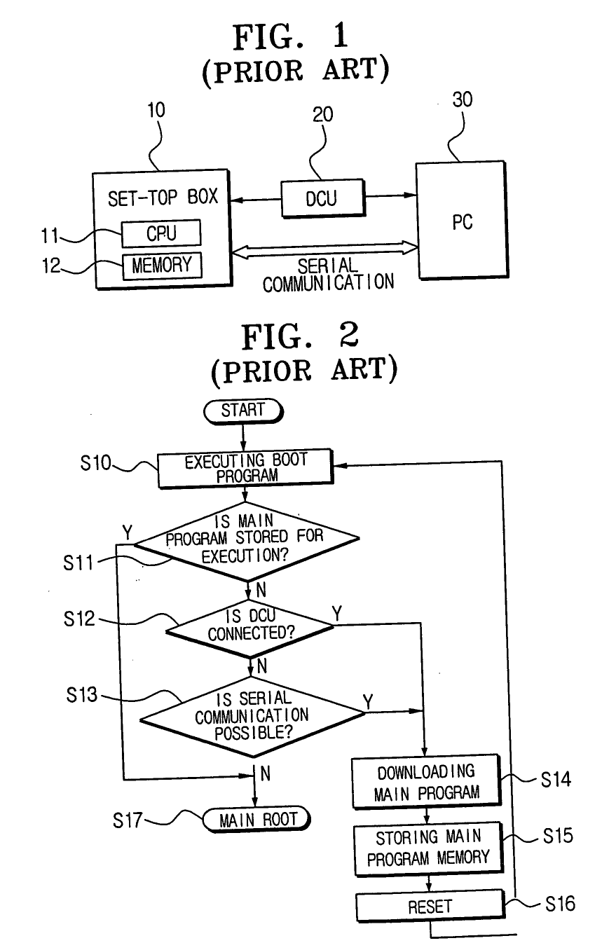

### DETAILED DESCRIPTION OF THE INVENTION

Reference will now be made in detail to aspects of the present invention, examples of which are illustrated in the accompanying drawings, wherein like reference numerals refer to like elements throughout. The aspects are described below in order to explain the present invention by referring to the figures.

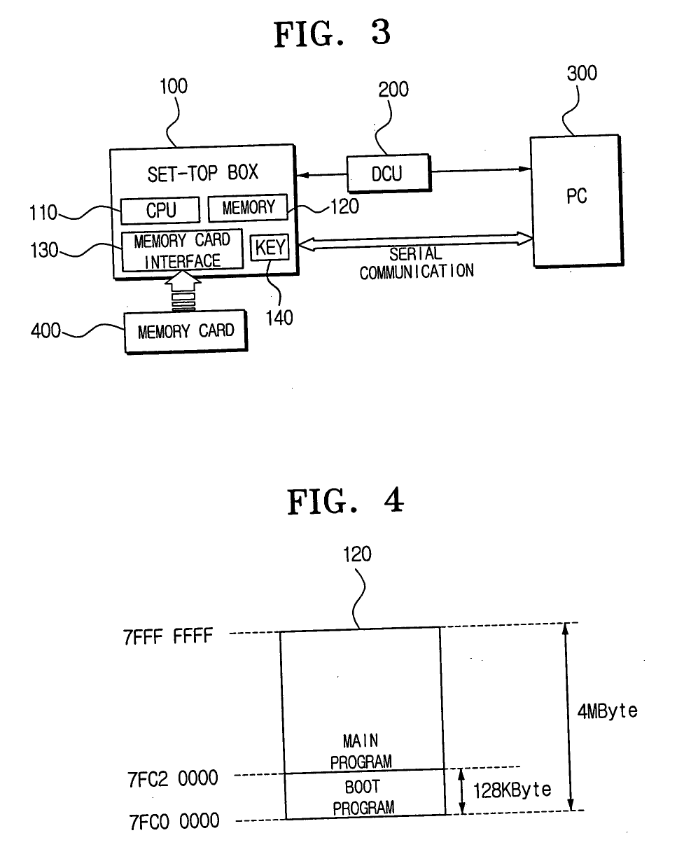

FIG. 3 is a block diagram showing a set-top box 100, which is one example of a digital receiver, according to an aspect of the present invention. As shown in FIG. 3, a memory card 400 storing a main program therein is mounted in a set-top box 100, according to an aspect of the present invention. The set-top box 100 includes a central processing unit 110 to control general operations of a system of the set-top box 100, a memory 120 to store information therein according to the control of the central processing unit 110, and a memory card interface 130 to connect the memory card 400 and the central processing unit 110.

The central processing unit 110 controls the general operations of the system of the set-top box 100 according to a program and a control command from a user. Particularly, when a memory card insert signal is input after the system is initialized with the execution of a boot program, the central processing unit 110 finds a main program-recorded file among files stored in the memory card 400 and downloads the main program-recorded file to the memory 120.

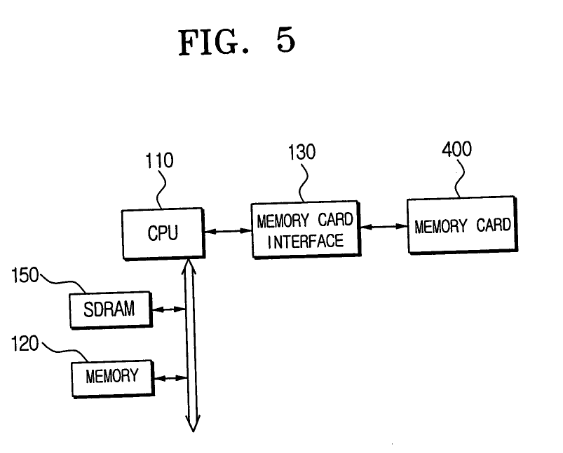

The memory 120 records and stores information therein under a control of the central processing unit 110 and also stores the boot program including information about the memory card interface 130. Also, the main program recorded in the memory card 400 is downloaded and recorded/stored in the memory 120 under the control of the central processing unit 110. The memory 120 may use a flash memory. FIG. 4 schematically shows a structure of the memory 120. The memory 120 as shown in FIG. 4 is a flash memory, a capacity of which is 4 MByte. Because the boot program stored in the memory 120 has a capacity of 128 KByte, the boot program can be recorded from an address 7FC0 0000 to an address 7FC1 FFFF and the main program can be recorded from the address 7FC2 0000. The capacity of the flash memory 120 can vary, i.e., 1 MByte, 2 Mbyte, and 4 Mbyte, according to a specification of an apparatus employing the memory 120.

Also, the set-top box 100 includes a key input unit 140 receiving the control command from the user. A predetermined key signal of the key input unit 140 is set as a memory card selection signal so that the main program can be directly downloaded from the memory card 400 by a manipulation of the predetermined key signal. According to an aspect of the present invention, the memory card selection signal may be set by a signal input when an up-key and a down-key are simultaneously pressed.

The memory card 400 uses a compact memory card such as a memory stick, a media card, a SD memory card, a compact flash or a smart media that can be removably mounted in a body and can be replaced with other ones. The memory card 400, according to an aspect of the present invention, stores therein a binary file extension, an executable extension, or a batch file extension. The main program is selected and stored by the user. Because the main program has a predetermined extension such as extension.bin, an executable extension,.exe, or a batch file extension,.bat, the central processing unit 110 finds a file having the predetermined file extension.bin, for instance, among the data stored in the memory card 400 and determines whether or not the file is the main program. Furthermore, the memory card 400 stores audio files, such as an MP3 file, and a WAV file and video files, such as a JPG file. The audio/video data distinguished from the main program by the extension is downloaded in response to a selection by the user after the execution of the main program and is processed in an audio/video DAC block using a predetermined application.

The memory card interface 130 performs a circuit interfacing with respect to the memory card 400 and allows the central processing unit 110 to control the address structure of the file recorded in the memory card 400.

The memory card 400 has 10 pins. Among these 10 pins, an ISN pin is connected to an insert recognition terminal of the memory card interface 130, i.e., a PIO terminal when the memory card 400 is inserted into the memory card interface 130 and connected thereto. Consequently, a logic voltage of the insert recognition terminal (PIO terminal) of the memory card interface 130 is converted to a “high logic voltage.” Based on the logic voltage (“high”) of the insert recognition terminal (PIO terminal), the memory card interface 130 generates an interrupt signal and supplies an insert signal to the central processing unit 110.

In addition, the insert signal can be recognized directly by the central processing unit 110 without passing through the memory card interface 130. For example, any one terminal of the GPIO terminals of the central processing unit 110 is designed to be used as a memory card insert recognition terminal. Accordingly, when the memory card 400 is inserted into the memory card interface 130, the ISN pin of the memory card 400 is directly connected to the GPIO terminal designed to be used as the memory card insert recognition terminal. Accordingly, the logic voltage of the GPIO terminal, which is designed to be used as the memory card insert recognition terminal, is converted to the “high logic voltage.” Based on the “high logic voltage of the GPIO terminal, the central processing unit 110 recognizes that the memory card 400 is inserted.

The boot program, according to an aspect of the present invention, stores information about the memory card interface 130 in a memory configuration area. Accordingly, the execution of the boot program enables the central processing unit 110 to recognize and control the data recorded in the memory card 400 through the memory card interface 130.

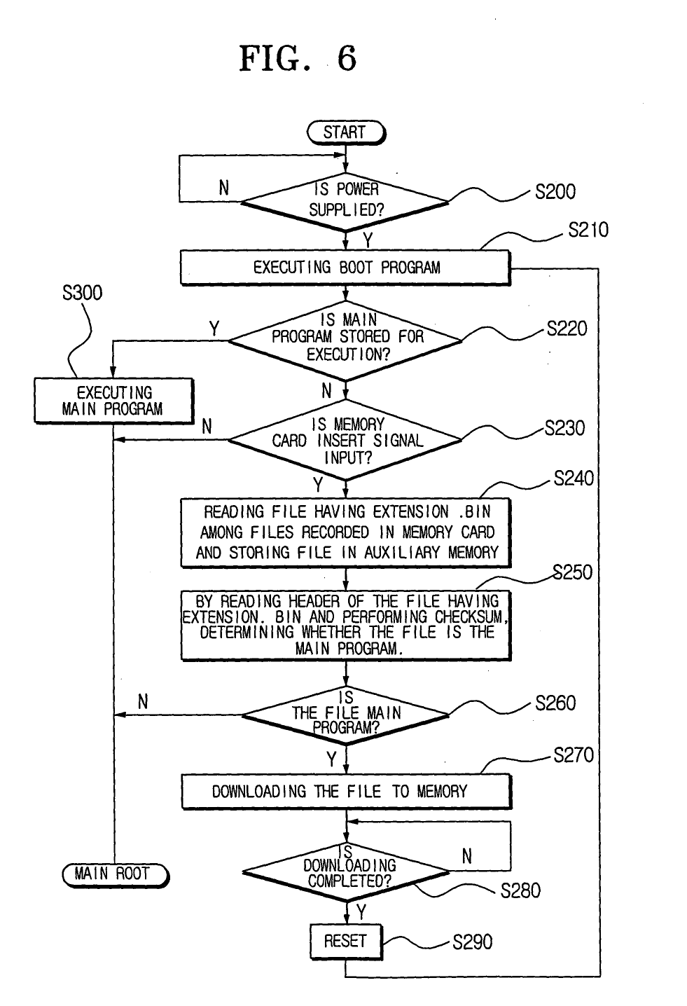

FIG. 5 is a block diagram showing a system of the set-top box 100, according to an aspect of the present invention, and FIG. 6 is a flowchart showing a process of downloading the main program from the memory card 400, according to an aspect of the present invention. Hereinbelow, the descriptions will be made about a controlling method of the set-top box 100 to download the main program with reference to FIGS. 5 and 6.

At operation S200, when a power is supplied, at operation S210, the boot program is executed and the system is initialized. After the initialization of the system, at operation S220, the process determines whether or not the main program is stored in the memory 120 for execution. When it is determined that the main program is available, at operation S300, the main program is executed to perform the functions of the set-top box 100.

Because the boot program includes information about the memory card interface 130, the system initialization enables the central processing unit 110 to recognize the memory card 400 through the memory card interface 130 and to control the information recorded in the memory card 400. When the memory card 400 is inserted into the memory card interface 130, the logic voltage of the insert recognition terminal (PIO terminal) is converted from “low” (0) to “high” (1). At this time, the memory card interface 130 causes an interrupt and sends the memory card insert signal to the central processing unit 110. At operation S230, when the central processing unit 110 detects the memory card insert signal, at operation S240, the central procession unit 110 finds a file having the predetermined file extension.bin, for instance, among the files recorded in the memory card 400 through the memory card interface 130 and reads and stores the file in an auxiliary memory 150, such as a SDRAM. By reading a header of the read file having the extension.bin and performing the checksum, at operation S250, the process determines whether the read file is the main program that the user intends to use. At operation S260, when the process determines that the read file is the main program, at operation S270 the file is downloaded to the memory 120. The main program-recorded file is recorded in the memory 120 from the address 7FC2 0000 because the boot program is recorded to the address 7FC1 FFFF. If the header does not accord with a recognition code or a checksum error occurs, at operations S260, the main program-recorded file is not recorded in the memory 120 and returns to a main root. Then, at operation S280, the process determines whether the file is accurately downloaded, by checking information of the file recorded in the header and capacity of the file recorded in the memory 120. When it is determined that the downloading is completed, the system is re-booted through a reset and executes operations S290, S210, S220, and S300.

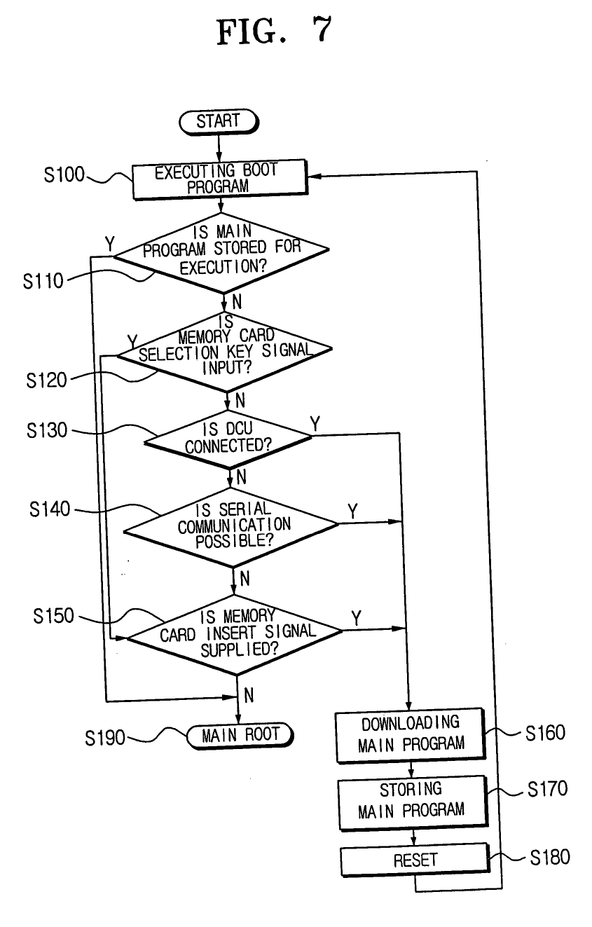

Meanwhile, the downloading of the main program can be performed in a method using a DCU or a serial communication instead of the method using the memory card as described above. FIG. 7 shows a process of downloading the main program using the DCU and the serial communication. When a power is supplied, at operation S100, the boot program is executed and, at operation S10, the program determines whether the main program is available.

If there is no main program stored or damage in the main program, the process to download the main program is performed. In order to download the main program directly from the memory card 400, at operation S120, the process determines whether the memory card selection key signal is input by the user. The memory card selection key signal can be set by an input signal of a predetermined key of the key input unit 140. Because the execution of the boot program does not allow the OSD menu to be displayed, the user manipulates the predetermined key of the key input unit 140 to input to the central processing unit 110, the memory card selection signal allowing the main program to be directly downloaded from the memory card.

When, at operation S120, the process determines that the memory card selection key signal is input, at operation S160, the main program is downloaded from the memory card 400 through the memory card interface 130. The downloading of the main program recorded on the memory card 400 is performed in the same process as that of FIG. 5.

The memory card selection key signal is pre-set by the predetermined key signal of the key input unit 140 provided on the set-top box 100 or a predetermined key signal of a remote controller. For example, if a channel-up key signal and a channel-down key signal of the key input unit 140 or the remote controller are set as the memory card selection key signal, the central processing unit 110 determines that the memory card selection key signal is input when the channel-up key signal and the channel-down keys signal are simultaneously input, and downloads the main program from the memory card 400 through the memory card interface 130.

When the memory card selection key signal is not input, the process determines whether it is possible to utilize the DCU 200 or the serial communication to download the main program.

When, at operation S130, the process determines that it is possible to download the main program from the PC 300 through the connected DCU 200, at operations S160 and S170, the main program is downloaded from the PC 300 through the DCU 200 and stored in the memory 120. If the DCU 200 is unavailable, it is determined whether the serial communication is available. When, at operation S140, the process determines that it is possible to download the main program using the serial communication, at operation S160, the main program is downloaded using the serial communication. At operation S170, the downloaded main program is stored in the memory 120.

If the serial communication is unavailable, at operation S150, the process determines whether or not the memory card insert signal is supplied to download the main program from the memory card. When the process determines that the memory card insert signal is supplied, at operations S160 and S170, the main program is downloaded from the memory card 400 through the memory interface 130 and stored in the memory 120. When the downloaded main program is stored in the memory 120, at operation S180, the system is re-booted through a reset and, at operation S190, the system returns to the main root to execute the main program. When the process determines that it is impossible to download the main program from the memory card 400, the system returns to the main root and displays an error.

According to the present invention, the main program can be downloaded from the external PC 300 using the DCU 200 and the serial communication. Also, even in the absence of the PC 300 and communication devices, the main program for performing functions of the set-top box 100 can be downloaded using the memory card 400 which is a portable memory.

Because the set-top box 100, according to an aspect of the present invention, can download the main program for performing the various functions of the set-top box 100 without requiring the PC 300, it is not restricted by space. Also, because the set-top box 100, according to an aspect of the present invention, uses the memory card 400 that is used to provide information such as MP3 files and image files, the set-top box 100 does not necessarily require the expensive DCU 200 and the serial communications. Accordingly, the programs can be downloaded and updated at a high speed and at a lowered cost.

Although a few aspects of the present invention have been shown and described, it would be appreciated by those skilled in the art that changes may be made in this embodiment without departing from the principles and spirit of the invention, the scope of which is defined in the claims and their equivalents.

What is claimed is:

1. A digital receiver, comprising:
a memory card storing a main program;
a memory;
a central processing unit controlling operations of the digital receiver and the memory;
a memory card interface electrically coupling the memory card and the central processing unit; and
a key input unit receiving a control command from a user and outputting a key signal to the central processing unit to control the memory card to directly download the main program from the memory card to the memory.

2. The digital receiver as recited in claim 1, wherein the main program has a predetermined file extension.

3. The digital receiver as recited in claim 1, wherein the memory card interface allows the central processing unit to control an address structure of the main program recorded in the memory card.

4. The digital receiver as recited in claim 1, wherein the memory stores information under a control of the central processing unit and stores a boot program having information about the memory card interface.

5. The digital receiver as recited in claim 4, wherein the memory stores a boot program in an upper memory area and the main program in a lower memory area.

6. The digital receiver as recited in claim 1, wherein the key signal is set by a signal input when an up-key and a down-key of the key input unit are simultaneously pressed.

7. The digital receiver as recited in claim 1, wherein the memory card comprises one of a memory stick, a media card, a SD memory card, a compact flash, and a smart media.

8. The digital receiver as recited in claim 1, wherein the memory card stores the main program to perform various functions of the digital receiver and to execute audio/video data.

9. The digital receiver as recited in claim 4, wherein the boot program enables the central processing unit to recognize the memory card through the memory card interface and to control the information recorded in the memory card.

10. The digital receiver as recited in claim 1, wherein the memory card comprises an ISN pin connected to an insert recognition terminal of the memory card interface.

11. The digital receiver as recited in claim 10, wherein when the memory card is inserted into the memory card interface, a logic voltage of the insert recognition terminal is converted from “low” (0) to “high” (1), and the memory card interface causes an interrupt and sends a memory card insert signal to the central processing unit to trigger a search of the main program in the memory card through the memory card interface.

12. The digital receiver as recited in claim 1, wherein the main program performs functions of the digital receiver comprising a User Interface (UI) and/or an Electronic Program Guide (EPG).

13. A method of downloading a main program from a memory card in a digital receiver, wherein the digital receiver comprises a central processing unit, a memory, a memory card interface, and a key input unit, the method comprising:
executing a boot program to initialize the digital receiver;
detecting a memory card insert signal triggering a search of a file having a predetermined file extension in the memory card through the memory card interface;
reading and storing the file in an auxiliary memory;
reading a header of the file read having the file extension and performing a checksum;
determining whether the file read is the main program;
downloading the main program to the memory; and
determining whether the main program is downloaded by checking information of the file recorded in the header and a capacity of the main program recorded in the memory.

14. The method as recited in claim 13, further comprising:
executing the main program to perform functions of the digital receiver when the main program is stored in the memory.

15. A method of downloading a main program from a memory card in a digital receiver using a data control unit (DCU) or a serial communication, wherein the digital receiver comprises a central processing unit, a memory, a memory card interface, and a key input unit, the method comprising:
executing a boot program;
receiving a memory card selection key signal to download a main program directly from the memory card through the memory card interface, wherein the memory card selection key signal is set by an input signal from the key input unit;
downloading the main program from the PC through the DCU when the memory card selection key signal is not input;
downloading the main program from the PC through the serial communication when the DCU is unavailable and the memory card selection key signal is not input;
storing the main program in the memory;
re-booting the system through a reset; and
executing the main program.

16. The method as recited in claim 15, further comprising:
determining whether a memory card insert signal is supplied to download the main program from the memory card when the serial communication and DCU are unavailable; and
downloading the main program from the memory card through the memory interface when the memory card insert signal is supplied.

17. The method as recited in claim 15, further comprising:
displaying an error when the main program cannot be downloaded from the memory card.

18. The method as recited in claim 15, wherein the user manipulates the key input unit to input to the central processing unit the memory card selection key signal allowing the main program to be directly downloaded from the memory card.

19. The method as recited in claim 15, wherein the memory card selection key signal is pre-set by the predetermined key signal of the key input unit provided on the digital receiver or a predetermined key signal of a remote controller.
